(19) United States
(12) Patent Application Publication
(10) Pub. No.: US 2025/0026165 A1
(43) Pub. Date: Jan. 23, 2025

(54) SUSPENSION COMPONENT

(71) Applicant: PerryParts LLC, Canaan, NH (US)

(72) Inventor: Patrick Perry, Canaan, NH (US)

(21) Appl. No.: 18/777,164

(22) Filed: Jul. 18, 2024

Related U.S. Application Data
(60) Provisional application No. 63/514,175, filed on Jul. 18, 2023.

(51) Int. Cl. B60G 7/04

(52) U.S. Cl. CPC B60G 7/04; B60G 2204/45

(57) ABSTRACT

A bump stop for a suspension system. The bump stop comprises an outer shell around an internal structure; and one or more ports. The outer shell retains air within the bump stop. Air is vented through the one or more ports. The internal structure includes a variable density infill structure. The outer shell is detached from the internal structure at one or more locations. A core includes sidewalls with accordion-style bellows. A base region has a higher density than the internal structure.

### BACKGROUND

Suspension systems are designed to provide a comfortable and controlled ride by absorbing shocks and vibrations from a surface upon which a vehicle is driven. Suspension systems are commonly used in a wide variety of vehicles, such as, for example, automotive vehicles, motorcycles, and bicycles. Suspension systems consist of various parts working together, including springs, shock absorbers, control arms, and anti-roll bars.

### SUMMARY

The present disclosure is directed to a vehicle's suspension. In particular a bump stop component on a vehicle's suspension. While the embodiments of this disclosure specifically describe the use of the bump stop on an automotive vehicle, the bump stop may also be implemented in a variety of other vehicle contexts, such as, for example, suspension systems implemented within motorcycles, bicycles, all-terrain vehicles, aircraft, recreational vehicles, commercial vehicles, and other vehicles using suspension systems.

As noted above, a bump stop is intended to limit the suspension's travel at the upper limit of the travel. It is important to have a bump stop in order to limit the suspension's travel, otherwise suspension components could contact the frame, or other unwanted components could come into contact, such as wheel contacting a fender, or there could be damage to shocks.

Existing bump stops have many shortcomings. The standard offering on most vehicles is a solid rubber block that the suspension contacts. The rubber block is stiff, and when the suspension contacts this style of bump stop, a jarring impact may be felt by the vehicle's operator.

Another existing bump stop design uses multi-cellular polyurethane, which can only offer one stiffness, and therefore often lacks sufficient suspension protection.

Finally, dual-durometer rubber bump stops offer a progressive stiffness that is soft during initial travel and firm deeper into travel. However, those dual-durometer products still do not offer a dynamic response based on the rate of impact on the suspension.

Finally, all rubber bump stops are prone to crack propagation, because should a crack begin in the material, it will propagate quickly through the bump stop, causing complete failure of the part.

One other design of bump stop is a hydraulic bump stop. These bump stops use a hydraulic damper to slow the rate of travel of the suspension prior to an ultimate stop. Some limitations to these products are the difficulty associated with mounting them onto the vehicle's suspension and their cost. Most vehicles are not designed to accommodate the additional size of a hydraulic bump stop, and therefore cutting or welding onto the frame of the vehicle is often required to create a mounting solution for hydraulic bump stops. In addition, hydraulic bump stops are on average five to ten times the price of the aforementioned bump stops.

Thus, existing solutions fail to properly address the dynamic nature of a vehicle's suspension while installing in the vehicle manufacturer's intended bump stop mounting locations at a reasonable cost. The concepts of the present disclosure help to accomplish at least some of the following goals: (1) the ability to mount the bump stop in existing factory bump stop locations; (2) the ability to vary the bump stop's stiffness based on the rate of compression of the vehicle's suspension; (3) the ability to resist failure of the bump stop from cracking by limiting crack propagation; and (4) the ability to be installed with minimal or no tools.

In one embodiment, a bump stop for a suspension system is described herein. The bump stop comprises an outer shell around an internal structure; and one or more ports. The outer shell retains air within the bump stop. Air is vented through the one or more ports.

### BRIEF DESCRIPTION OF THE DRAWINGS

FIG. 1 is an image of an example control arm with a spring-mass-damper shock absorber and an example bump stop.

FIG. 2 is an image of a straight axle with shock absorbers, springs, and another example bump stop.

FIG. 3 is a cross-sectional view of the example bump stop of FIG. 1.

FIG. 4 is a cross-sectional view of a bump stop with a traditional solid rubber body.

FIG. 5 is a graphical depiction of progressive, linear, and digressive spring rates.

FIG. 6 is a cross-sectional view of a bump stop with a 3D-printed body in a gyroid fill pattern and a partially detached shell.

FIG. 7 is a cross-sectional view of the bump stop of FIG. 6.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

One important element within a suspension system is the bump stop.

A vehicle's suspension is typically an unsprung mass, such as a control arm or an axle. This unsprung mass is typically attached to one of the wheels of the vehicle. The suspension typically consists of a spring-mass-damper system, where the vehicle's body and frame (the sprung mass) are suspended on top of the unsprung mass (such as the axles, wheels, and control arms).

A bump stop sits between the unsprung mass of the suspension and the sprung mass of the vehicle. The intent of a bump stop is to provide a smooth transition from typical suspension travel and the hard limit of the suspension's travel. The bump stop limits the suspension travel when the vehicle encounters a large bump or pothole. It acts as a buffer between the suspension components and the vehicle frame, preventing excessive compression or extension of the suspension system beyond its designed limits.

When the vehicle encounters a bump, the suspension system compresses to absorb the impact. If there were no bump stop in place, the suspension components, such as the springs or shock absorbers, could bottom out or overextend, leading to potential damage. The bump stop acts as a mechanical barrier, preventing these components from reaching their limits and protecting them from excessive forces.

The bump stop also helps to enhance the stability and handling of the vehicle. By limiting the suspension travel, it helps to maintain consistent tire contact with the road surface. This improves traction and grip, allowing the vehicle to maintain control and stability during sudden maneuvers or when driving on uneven surfaces. Without the bump stop, the suspension could bottom out or become unbalanced, compromising the vehicle's handling and potentially causing a loss of control.

In addition to its protective and stability-enhancing functions, the bump stop also contributes to the overall comfort of the vehicle. It helps to reduce harsh impacts and vibrations transmitted from the road surface to the cabin, ensuring a smoother and more enjoyable ride for the occupants. By absorbing and dispersing the energy generated by bumps and potholes, the bump stop plays a significant role in minimizing discomfort and fatigue for both the driver and passengers.

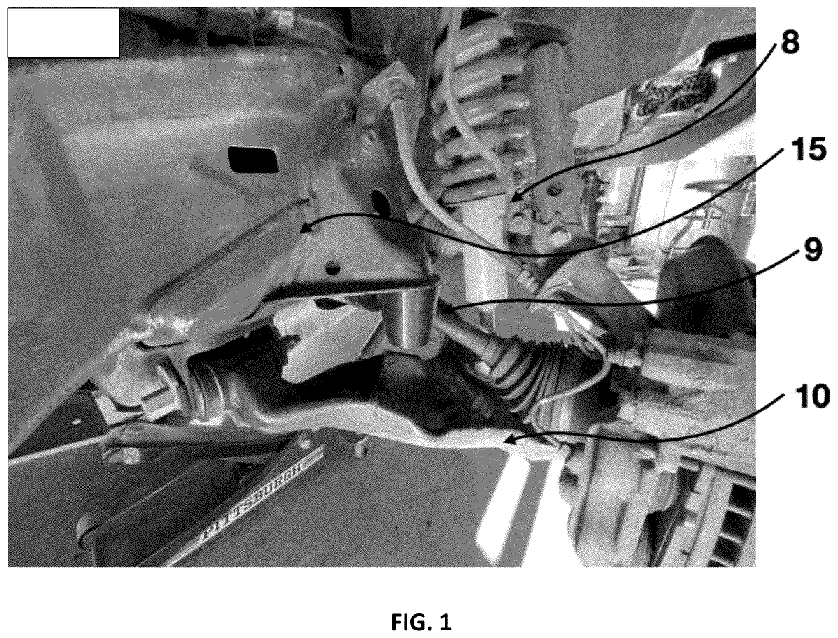

FIG. 1 is an image of a control arm 10 with a spring-mass-damper shock absorber 8. In this image, an example bump stop 9 can be seen. A sprung mass 15 is suspended above the control arm 10 with the bump stop 9 attached to the bottom of the sprung mass 15. The bump stop 9 is positioned so that it will contact the control arm 10 when the shock absorber 8 is compressed, thereby preventing the sprung mass 15 from contacting the control arm 10.

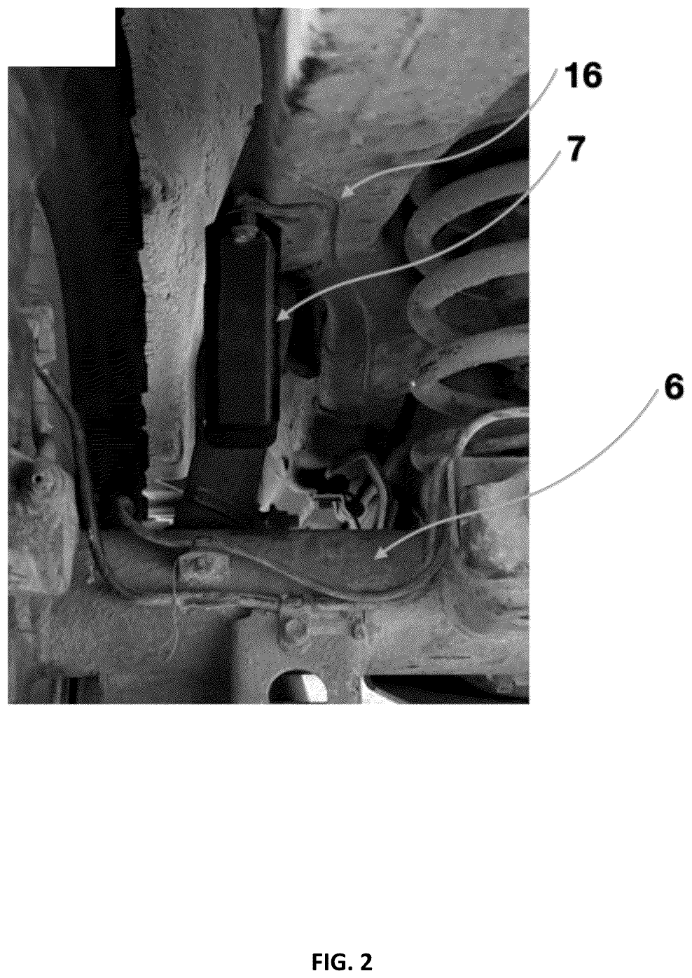

FIG. 2 is an image of a straight axle 6 with shock absorbers and springs. In this image, another example bump stop 7 can be seen. In this embodiment, the bump stop 7 has a rectangular shape and is attached parallel to the edge of a sprung mass 16. As in the previous embodiment, this bump stop 7 prevents the sprung mass 16 from contacting the straight axle 6 when the suspension travels.

Referring to FIG. 1 and FIG. 2, the bump stop 7, 9 is arranged between the unsprung mass 10, 6 and the sprung mass 15, 16 of the vehicle. In some embodiments, the bump stop 7, 9 is attached to the vehicle's frame. In other embodiments, the bump stop 7, 9 does not mount to the vehicle's frame, and is instead mounted to the unsprung mass, such as, for example, a control arm or an axle. In each of these embodiments, the bump stop 7, 9 acts as a barrier between the sprung mass and the unsprung mass to prevent their contact when the vehicle's suspension travels.

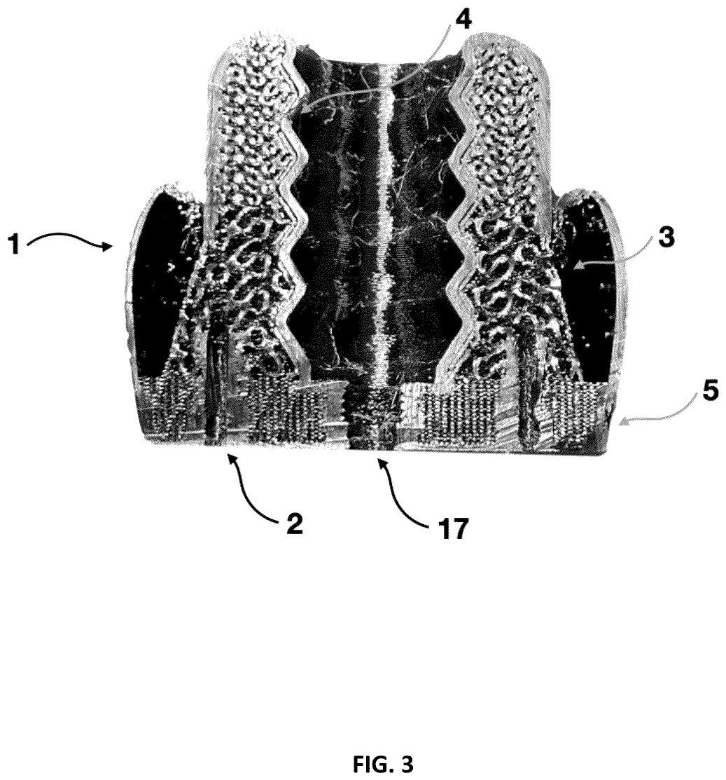

FIG. 3 is a cross sectional view of another example bump stop 1. In this embodiment, the bump stop 1 has an internal structure 3 that may be porous and may be created using a 3D printer. The bump stop 1 also has accordion-style bellows 4 in its center, and an integrated lock ring 17 that may aid in installing the bump stop. The bump stop also has a base region 5 that may have a different density than the bump stop's internal structure 3 and encourages the bump stop to compress more in the region of its internal structure 3 and less in the region of its base region 5.

In some embodiments, the outer shell of the bump stop 1 acts as an airbladder in order to hold air pressure internally inside the bump stop 1. This internal air pressure is then selectively vented through ports 2 at the bottom of the bump stop 1. These ports 2 are specifically tuned to be a specific diameter to meter the rate of air escape, thus enabling the air to assist in contributing to the bump stop's 1 stiffness. Additionally, when the bump stop 1 is compressed more quickly, the bump stop 1 will seal against its mounting surface, to further meter the air escape out the bottom ports 2. In some examples, the degree to which the bump stop 1 will seal against its mounting surface is dependent on the rate of compression of the bump stop 1.

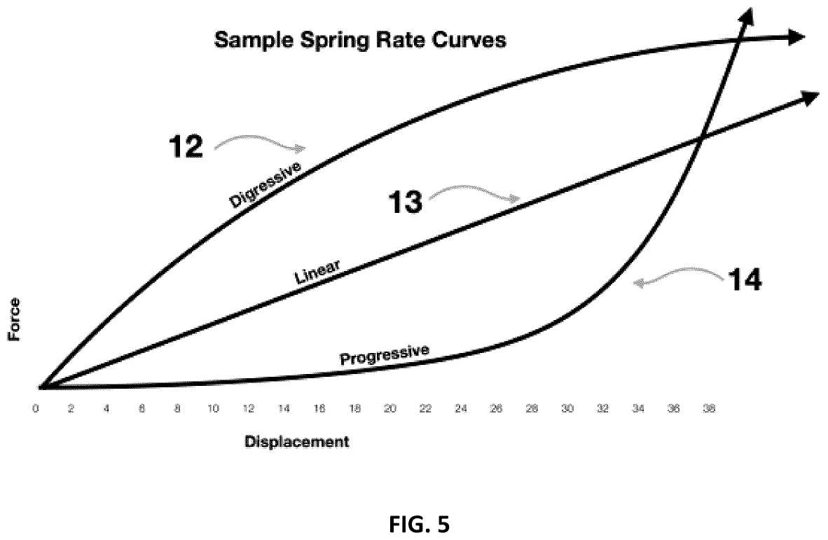

In some embodiments, the internal structure 3 of the bump stop 1 is created using a variable-density infill structure. By increasing the density of the internal structure 3, the effective stiffness of the bump stop 1 will increase. Thus, by creating a gradient of densities, the internal structure 3 of the bump stop 1 has variable stiffnesses. This is desirable because it allows for complete adjustability of the force/displacement curve of the bump stop 1, to create progressive 14, linear 13, or digressive 12 spring rate curves, as shown in FIG. 5. Additionally, because the internal structure 3 is not continuous, should a crack develop in the product, it will not propagate and spread throughout the bump stop 1, which would cause complete failure.

In some embodiments, the core of the bump stop 1 is hollow and is created using sidewalls with accordion-style bellows 4. The accordion-style bellows 4 structure is more prone to collapse than the exterior walls of the bump stop, allowing the bump stop 1 to compress at the core and minimizing undue stress on the outer shell of the bump stop 1.

In some embodiments, the base region 5 of the bump stop 1 has a higher density than the internal structure 3. In some embodiments, the base region 5 is created at full density to provide sufficient support. For example, in some embodiments, the base region 5 is solid. Like the internal structure 3, a higher density results in a higher stiffness region. A stiff base region 5 provides support for the rest of the structure of the bump stop 1 and ensures that the bump stop 1 is robust.

The integrated threads and lock ring 17 are designed to capture hardware inside the bump stop 1. The bump stop 1 may include a captive bolt which enables a tool-free install by the consumer. With this design, the integrated threads provide a lead-in feature for a bolt to be installed into the bump stop 1, and the locking ring ensures that the bolt does not slip after the bolt is added to the bump stop 1.

In some embodiments, the features described with reference to FIG. 3 may be implemented in a variety of different contexts, such as within the bump stops 7 and 9 of FIGS. 1 and 2. In some embodiments, the features described with reference to FIG. 3 may be implemented in a variety of types of vehicles that have suspension systems.

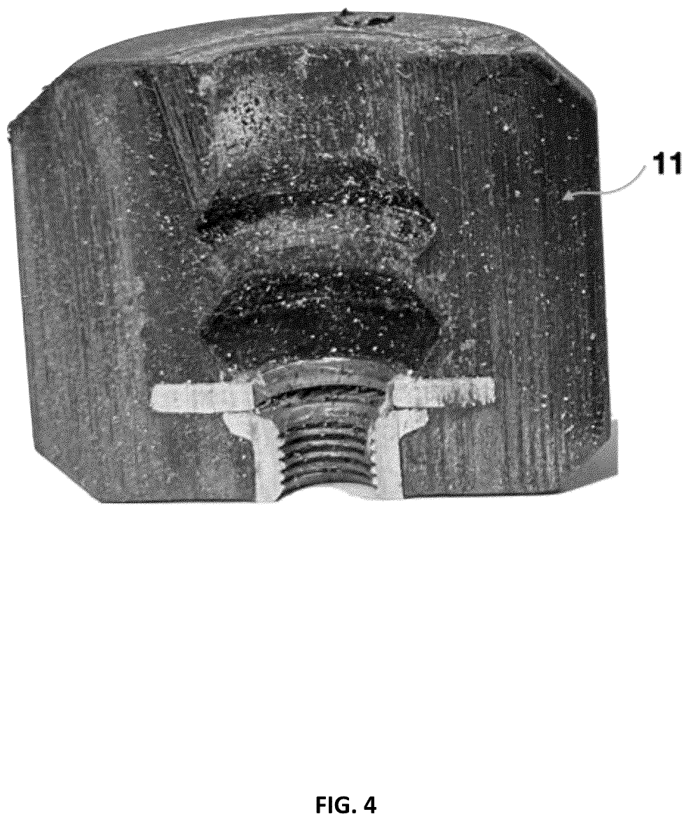

FIG. 4 is an image of a cross-section of a bump stop 11 with a traditional solid rubber body. The bump stop 11 lacks the porous internal structure of the embodiment depicted in FIG. 3 and also lacks a variable internal structure as previously described.

Referring to FIG. 5, known dual-durometer rubber solutions offer a progressive stiffness, as shown by curve 14, that is soft in initial travel and firm deeper into travel. However, those dual-durometer products still do not offer a dynamic response based on the rate of impact on the suspension.

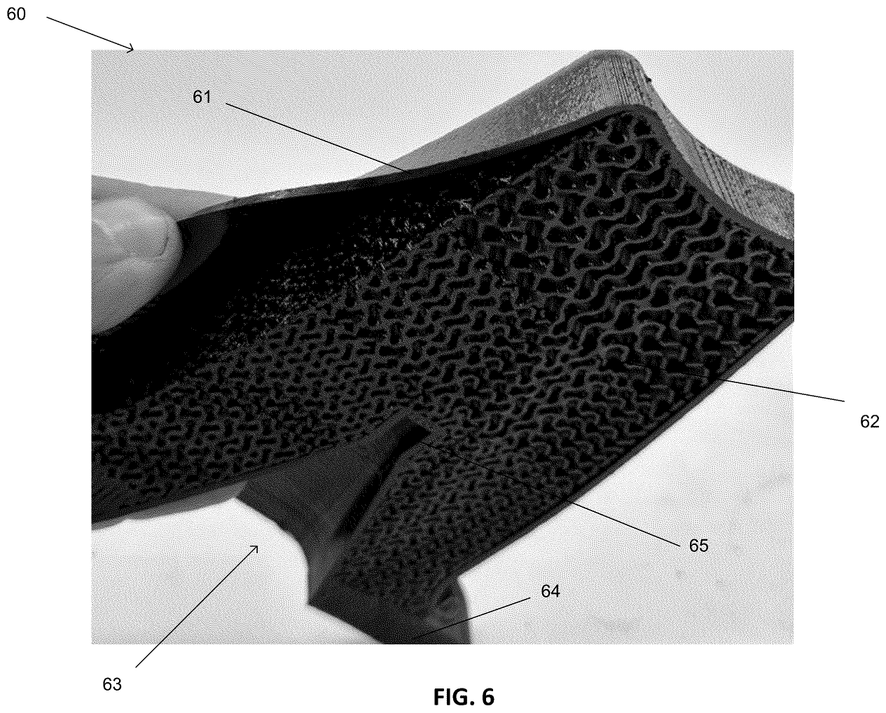

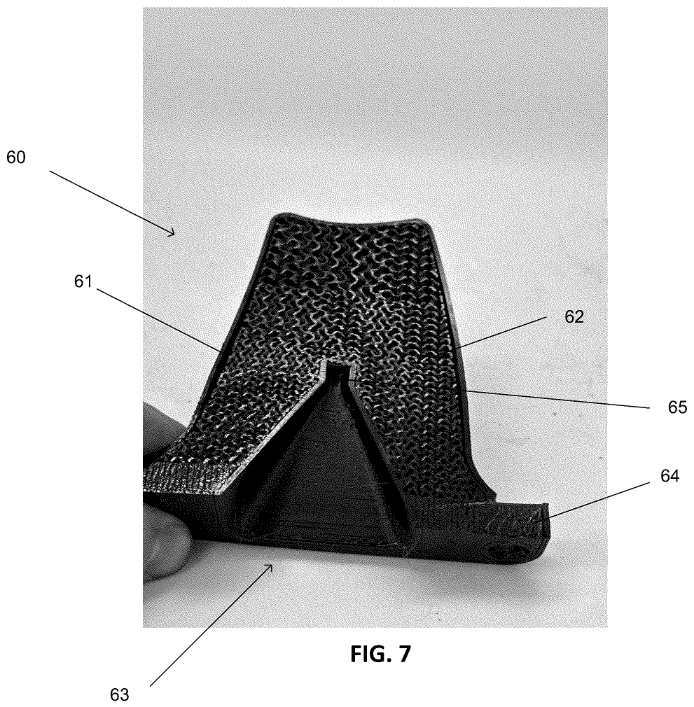

Referring to FIG. 6 and FIG. 7, another embodiment of a bump stop 60 is shown. FIG. 6 and FIG. 7 are cross-sectional views of the same bump stop 60. The bump stop 60 has an outer shell 61 and an internal structure 62 that may be porous and may be created using a 3D printer. The outer shell 61 is detached from the internal structure 62 at one or more locations, enabling it to flex independently from the internal structure 62. In some examples, the outer shell 61 is attached to the internal structure 62 at the top and bottom sides of the bump stop 60 but is detached from the internal structure 62 along a side region of the bump stop 60 that is between the top and bottom sides of the bump stop 60.

This embodiment allows the outer shell 61 to bend outwards away from the internal structure when the bump stop 60 is compressed, decreasing the intensity of stress on the outer shell 61. Instead of being forced to conform to the shape of the internal structure 62 as the bump stop 60 is compressed, which the outer shell 61 may be if it were attached to the internal structure 62, the outer shell 61 instead bends at fewer points and at an angle that is less sharp when the bump stop 60 is compressed than it otherwise may be when attached to the internal structure 62. This preserves the integrity and promotes longevity of the outer shell's 61 material.

Additionally, the bump stop 60 has a clearance region 63 that may create clearance relative to other components of the vehicle and aid in the placement of the bump stop. The clearance region 63 may be triangular as illustrated or it may have some other shape. The bump stop also has a vent 65 that allows internal air pressure to escape in a manner comparable to the ports 2 in other embodiments. The vent 65 may be connected to the clearance region 63 or it may be separate from the clearance region 63. In some examples, as shown in FIG. 6 and FIG. 7, the vent 65 is arranged at a top end of the clearance region 63.

The bump stop 60 also has a base region 64 that may have a different density than the bump stop's 60 internal structure 62 and encourages the bump stop 60 to compress more in the region of the internal structure 62 and less in the region of its base region 64. The base region 64 provides support for the rest of the bump stop 60.

In some examples, a rectilinear fill pattern is one fill pattern that can be used to create the internal structure 62 of FIG. 6 and FIG. 7. In some examples, the rectilinear fill pattern is fabricated by 3D printing. The rectilinear fill pattern has some advantages over other fill patterns, such as its speed and efficiency. Compared with a simple grid fill pattern, the rectilinear fill pattern uses less material and is less prone to print failure. However, the rectilinear fill pattern may also be less solid because of less adhesion between print layers than a simple grid fill pattern or other fill patterns.

In some examples, a gyroid fill pattern is another fill pattern that can be used to create the internal structure 62 of FIG. 6 and FIG. 7. In some examples, the gyroid fill pattern is fabricated by 3D printing. Advantages of this fill pattern are its exceptional strength properties and stress resistance. Additionally, the gyroid fill pattern can print slightly more quickly than the rectilinear fill pattern, depending on the 3D printing technology used. Finally, the gyroid fill pattern is nearly isotropic, maintaining its strength regardless of its orientation with respect to the bump stop 60. Both the rectilinear fill pattern and the gyroid fill pattern are possible fill patterns for the internal structure 62 of the bump stop 60. In some examples, the gyroid fill pattern provides a more linear spring rate, whereas the rectilinear fill pattern provides a more progressive spring rate. In some examples, the rectilinear fill pattern requires less total material to provide equivalent stiffness to the gyroid fill pattern. In some examples, the rectilinear fill pattern is able to be printed faster than the gyroid fill pattern.

In some examples, different fill patterns may be used to change the behavior of the bump stop. For example, certain fill patterns may be used to provide more progressive and digressive characteristics. Likewise, certain patterns may be used to provide a combination of progressive and digressive characteristics in the response of the bump stop. In addition to the rectilinear and gyroid fill pattern, in some examples, other fill patterns may be used in the internal structure or the base region of the bump stock. In some examples, such fill patterns may comprise any one or more of a grid, triangular, honeycomb, cubic, octet, concentric, cross, 3D honeycomb (gyroidal), zigzag, or adaptive cubic.

By the above description and information, the embodiments described above offer many advantages over existing bump stop solutions. The dynamic nature of the bump stop to meet the rate of compression of the suspension, coupled with the complete ability to tune the bump stop's stiffness without having to change materials or compounds for a specific vehicle provide an effective solution as a bump stop.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A bump stop for a suspension system, the bump stop comprising:
an outer shell around an internal structure; and
one or more ports;
wherein the outer shell retains air within the bump stop; and
wherein air is vented through the one or more ports.

2. The bump stop of claim 1, wherein the one or more ports are tuned to a specific diameter to meter a rate at which the air is vented through the one or more ports.

3. The bump stop of claim 1, wherein the one or more ports are arranged on a bottom surface of the bump stop.

4. The bump stop of claim 3, wherein the bottom surface of the bump stop is configured to be arranged against a surface of a vehicle such that when the bump stop is compressed, the bottom surface seals against the surface of the vehicle to limit an amount of air vented through the one or more ports.

5. The bump stop of claim 1, wherein the internal structure comprises a variable density infill structure.

6. The bump stop of claim 5, wherein the bump stop has a variable stiffness.

7. The bump stop of claim 5, wherein the internal structure is discontinuous.

8. The bump stop of claim 1, further comprising a hollow core with internal sidewalls.

9. The bump stop of claim 8, wherein the internal sidewalls are created using accordion-style bellows.

10. The bump stop of claim 1, wherein the bump stop further comprises a base region with a higher density than the internal structure.

11. The bump stop of claim 10, wherein the base region is a solid region.

12. The bump stop of claim 10, wherein the base region has a greater stiffness than the internal structure.

13. The bump stop of claim 1, wherein the bump stop further includes integrated threads and a lock ring.

14. The bump stop of claim 13, wherein the integrated threads provide a lead in feature for a bolt to be installed into the bump stop.

15. The bump stop of claim 14, wherein the lock ring ensures that the bolt does not slip after the bolt is added to the bump stop.

16. The bump stop of claim 1, wherein the outer shell is detached from a portion of the internal structure.

17. The bump stop of claim 16, wherein the outer shell is attached to the internal structure at a top side and a bottom side of the bump stop and is detached from the internal structure at a side region of the bump stop that is between the top side and bottom side of the bump stop.

18. The bump stop of claim 1, wherein the internal structure comprises a gyroid fill pattern.

19. The bump stop of claim 1, wherein the internal structure comprises a rectilinear fill pattern.

20. The bump stop of claim 1, wherein the internal structure comprises any one or more of a grid, triangular, honeycomb, cubic, octet, concentric, cross, 3D honeycomb (gyroidal), zigzag, and adaptive cubic fill pattern.
